(19) United States
(12) Patent Application Publication
(10) Pub. No.: US 2023/0356451 A1
(43) Pub. Date: Nov. 9, 2023

(54) METHOD AND APPARATUS FOR PRODUCING PLASTIC CONTAINERS WITH ZONE INDICATORS INSPECTION OF PLASTIC PREFORMS

(71) Applicant: KRONES AG, Neutraubling (DE)

(72) Inventors: Jochen FORSTHOEVEL, Regensburg (DE); Robert AUST, Illkofen (DE); Stefan SCHOBER, Tegernheim (DE)

(21) Appl. No.: 18/195,240

(22) Filed: May 9, 2023

(30) Foreign Application Priority Data
May 9, 2022 (DE) 10 2022 111 523.2

(51) Int. Cl. B29C 49/78; B29C 49/00

(52) U.S. Cl. CPC B29C 49/78; B29C 49/0005; B29C 2049/7876; B29C 2049/78745; B29C 2049/78755

(57) ABSTRACT

A method for evaluating plastic preforms, wherein said plastic preforms are intended to be heated by a heating device and then expanded by a forming device by application of a flowable medium to form plastic containers, wherein the plastic preforms extending in a longitudinal direction and having several portions in the longitudinal direction, wherein the several portions having at least one threaded portion, a main body portion and a bottom portion, wherein at least the main body portion and the bottom portion being inspected, wherein values characteristic of a material quality of the plastic preforms are output, wherein the values being assigned to different portions and/or at least one property of the container to be produced being taken into account in the evaluation of the characteristic values.

### BACKGROUND OF THE INVENTION

The present invention relates to an apparatus and a method for producing plastic containers. Such apparatus and methods have long been known from the prior art. Conventionally, plastic preforms are used for the production of plastic containers, which are initially heated and then expanded by application of a flowable medium, for example compressed air, to form containers such as plastic bottles.

More recently, it has become increasingly necessary to use recyclate or partially recycled material as material for these plastic preforms. However, this often leads to a poorer and in particular more inhomogeneous quality of the plastic preforms. For example, the material can have darker inclusions which are heated more strongly in a heating device such as an infrared heating device. This can lead to considerable problems during the production of the containers. Thus, darker regions can be heated to a greater extent in an infrared furnace, and said regions and the surrounding material are then stretched more intensely therefore in a blow-molding machine, which can lead to greater inhomogeneities and, for example, also to the bursting of containers.

WO 2020/177982 A1 discloses a method for product guidance in a stretch blow-molding machine. WO 2012/001414 A2 describes an apparatus and a method for inspecting plastic preforms.

It is therefore known in the prior art that these plastic preforms are inspected. In this case, plastic preforms which do not correspond to the quality criteria are sorted out. In particular because more recyclate is being used, the detection of, for example, so-called black specks in the plastic preform, that is to say of carbonized foreign material, is becoming increasingly important.

In the prior art, the main body of the plastic preform is inspected and a decision is made on the basis of the inspection result as to whether the plastic preform is to be excluded. However, this partially results in a relatively high degree of sorting out. If the plastic preform is blown into a bottle, it heats up more intensely at a point with a dark contamination of the material in the infrared heating module, and, as mentioned above, a thin spot up to a hole in the container results.

The object of the present invention is therefore to reduce the waste of such plastic preforms. This is achieved according to the invention by the subject matter of the independent claims. Advantageous embodiments and de-velopments are the subject matter of the dependent claims.

In a method according to the invention for evaluating plastic preforms, wherein said plastic preforms are intended to be heated by a heating device and then expanded by a forming device by applying a flowable medium to the plastic containers, said plastic preforms extend in a longitudinal direction and have several portions in said longitudinal direction, wherein said several portions having at least a threaded portion and/or a mouth portion, a main body portion and a bottom portion. At least the main body portion and the bottom portion are inspected.

According to the invention, characteristic values are output for a material quality of the plastic preforms and said values are assigned to different portions and/or are also characteristic of different portions of the plastic preform. Additionally or alternatively, at least one property of the container to be produced is taken into account in the evaluation of said characteristic values.

In the prior art, the plastic preforms have previously been inspected homogeneously and no distinction was made between the portions of the plastic preform.

### SUMMARY OF THE INVENTION

However, the applicant has found that not only the color and size of the soiling, but also its position in the plastic preform is decisive for the effects of a dark contamination in the plastic preform. The risk that an imper-missibly thin place or a hole results in the container rises with the local de-grees of stretching during the blow-molding process and is thus greater in the regions in which, for example, the container is placed in the blow mold.

The generally particularly thin foot region of the container is generally formed from the region of the plastic preform which is located directly above the bottom of the plastic preform. Impurities detected in this region can therefore expediently be rated as more serious than impurities in the remaining main body of the plastic preform.

The second embodiment of the invention therefore proposes, during the evaluation of the characteristic values and/or during the assessment of the question as to whether a specific plastic preform is to be sorted out, that at least one property of the container to be produced also be taken into account.

In particular, said property of the container to be produced is a geometric shape of the container to be produced, in particular a shape of a bottom region and/or main body region of the container to be produced. Thus, for example, containers are known which have a so-called champagne bottom, i.e., a bottom which is designed without feet. In other bottoms, numer-ous feet can be formed, which therefore also lead to regions of intense stretching.

However, the main bodies of the containers to be produced can also be designed in different ways. For example, said main bodies can have regions with grooves or the like or can also be smooth.

In a further preferred method, the property of the container to be produced is a desired wall thickness. For example, in the case of reusable containers, the walls of the container are thus made thicker than in disposable containers. In addition, in the case of some species of containers, the bottoms thereof are designed to have thicker walls than in other containers. In the case of such a thicker walled configuration, more imperfections can be tolerated than in the case of a thinner walled configuration.

In this way, the invention proposes that, in addition to the type of contamination, it is also possible to take into account where this contamination is located and/or which container is to be produced.

The advantages of the invention are particularly important in the cur-rently required increase in the portions of recyclate with decreasing recyclate quality (due to lower availability of high-quality post-consumer material). As a result of this evaluation of detected impurities (or also by taking into account the shape of the containers to be manufactured) weighted according to portions or according to zones, it is possible to reduce the ejection of non-critical plastic preform defects and that of critical ones can nevertheless be carried out.

This leads overall to a smaller number of defectively blow-molded containers, with simultaneous reduction of the ejection rate. In a particularly preferred method, the expansion of the plastic preforms takes place by means of a blow-molding machine and in particular a stretch blow-molding machine. The plastic preform is preferably closed with the exception of its threaded mouth. The region from which the bottom portion of the container is later produced is preferably also a bottom portion of the plastic preform and in particular a region which is located around the so-called injection point of the plastic preform.

In particular, the bottom portion is the region which is expanded in a blow mold into a bottom shape of this blow mold. As mentioned above, said portion is subject to particularly high expansions or strains.

In a preferred method, the inspection is performed contactlessly. Particularly preferably, at least one image of the plastic preform and/or a portion of the plastic preform is recorded. It is possible here for the plastic preform to be inspected in a transmitted light method or in a reflected light method.

In a preferred method, at least one image of the plastic preforms to be inspected is recorded with at least one image recording device.

In a further preferred method, the plastic preforms to be inspected are illuminated by an illumination device. This illumination device can output UV light, light in the visible wavelength range and/or light in the (close) infrared wavelength range.

In a further preferred method, the plastic preforms to be inspected are inspected by means of a thermal imaging camera, in particular after the heating.

In a preferred method, the values that are characteristic of the material quality are selected from a group of values which includes impurities of the material of the plastic preforms, sizes of the impurities of the material, a distribution of the impurities of the material over the surface thereof, a density of the impurities of the material over the surface thereof, thickness fluctuations of a material of the plastic preforms, density fluctuations of the material of the plastic preforms, color properties of the material of the plastic preforms and the like.

As mentioned above, the impurities are determined and/or evaluated both in a main body portion of the plastic preform and in a bottom portion of the plastic preform. However, such impurities which occur in a main body portion are particularly preferably assessed differently to impurities which occur in the bottom portion of the main body or of the plastic preform.

Thus, for example, a number and size of impurities in the main body can lead to different results in the context of the assessment of the plastic preform (for example to an ejection or to further treatment) than a compara-ble or equal density or number of impurities in a bottom portion. While the number of impurities in a main body can still lead to the relevant plastic preform being assessed as good and thus further processable, the same number or density of impurities in the bottom portion of the plastic preform can result in the latter being assessed as unusable and being ejected according-ly.

In the case of a preferred method, the material properties are thus assessed in a zone-by-zone or portion-by-portion manner. In the example shown here, it has been mentioned that the plastic preform is divided into two portions, namely on the one hand a main body portion and on the other hand a bottom portion. However, it would also be conceivable to make this division even finer and, for example, to assess a region of the plastic preform directly around its injection point differently to further bottom regions of the plastic preform and also differently to regions of the main body.

The main body could also be subdivided into sub-portions, for example a sub-portion which is directly below a support ring of the plastic preform and into other regions. Such differentiations or portions can also be selected depending on the type of container being produced. Thus, for example, the assessment of the bottom portion can also be made dependent on how com-plex or how exact the configuration of the bottom is. If, for example, the bottom is a so-called champagne bottom, the bottom portion can be evaluated differently to a container which is produced with a plurality of feet.

Therefore, the specific container to be produced is also particularly preferably taken into account during the inspection and/or assessment of the material properties. A volume of the container to be produced can also be taken into account. Parameters of the forming process for the inspection or the assessment of the inspection result can also be taken into account.

In a further preferred method, at least one characteristic value is determined which is characteristic of the main body portion of the plastic preforms and/or at least one characteristic value is determined which is characteristic of the bottom portion and/or a wall portion of the plastic preforms. With regard to the wall portion of the plastic preforms, it must be taken into account that support rings are formed in the circumferential walls in part in containers, which support rings can also represent sensitive regions during the blow molding.

For example, a value can be determined which is characteristic of a number or density of the impurities in the main body portion and a further value which is characteristic of a density or number of impurities in the bottom portion. These values are preferably taken into account in order to de-cide whether the relevant plastic preform is to be ejected. It is preferably checked separately whether the main body portion still corresponds to predetermined target criteria and/or whether the bottom portion meets predetermined target criteria. These target criteria can preferably be selected differently.

In a further preferred method, the main body of the plastic preforms is inspected and a value characteristic of this main body portion is output. Furthermore, the bottom portion of the plastic preforms is preferably inspected and a value is output which is characteristic of this bottom portion. In the case of a further preferred method, an evaluation is made both and preferably separately for the main body portion and for the bottom portion, as to whether they still meet certain target criteria. Preferably, these criteria are selected differently for the main body portion of the plastic preform and the bottom portion of the plastic preform.

In a preferred method, the plastic preforms are transported along a predetermined transport path and inspected during this transport. In this proposed method, the inspection is carried out effectively online and preferably during ongoing operation. In this method, each plastic preform is inspected individually. However, it would also be possible to carry out an inspection of the plastic preforms outside of the operation, for example in a separate installation or a separate device. It would then be possible to eject plastic preforms already and not just allow them to reach the production operation. Preferably, however, an inline inspection is proposed.

In a further preferred method, the plastic preforms are transported along a predetermined transport path and inspected during this transport.

Particularly preferably, only the part of the preform to be stretched is assessed for further processing.

In a further preferred method, the plastic preforms have a predetermined proportion of recycled material. Preferably, this proportion is higher than 10%, preferably higher than 20% and preferably higher than 30% and particularly preferably higher than 40%.

In a preferred method, the plastic preforms are heated after their inspection and, in particular, also expanded after their heating. In this method, the inspection is preferably carried out upstream of a heating device, for example before a sawtooth star wheel, which synchronizes the plastic preforms in order thus to be supplied to the heating process.

In a preferred method, a portion of the plastic preforms is ejected before the expansion thereof and in particular after the heating thereof. However, it would also be possible for the ejection to still take place before the heating. If, for example, it is determined that a certain plastic preform does not meet the predetermined criteria because it has in its main body portion or its bottom portion, for example, a number or a density of impurities which no longer satisfies predetermined criteria, this specific plastic preform can be ejected.

In a preferred method, this ejection takes place after the heating of the plastic preforms because an ejection or a generation of gaps in the furnace often also leads to disadvantages of the adjacent plastic preforms. However, it would also be possible to eject the plastic preforms in question before the heating, in particular if the resulting gaps are subsequently closed again. It is thus possible to eject individual plastic preforms before they reach a syn-chronization star of a corresponding installation.

In a further preferred method, an ejection takes place taking into account at least one of the values and particularly preferably the ejection takes place both taking into account at least one of the values and taking into account the portion in which this value was determined.

It is thus possible for a first tolerance window to be defined for the main body portion and a second tolerance window for the bottom portion. Furthermore, it is possible that, as mentioned above, a higher degree of faults is allowed for the main body portion, or the tolerance window allows a higher type or number of faults. It is particularly preferably possible to deter-mine both the size of imperfections or foreign bodies and a density based on a surface portion.

In a preferred method, in the context of the inspection, at least one image of a plastic preform to be inspected is recorded. In a preferred method, the recorded images are evaluated and, in particular, evaluated with regard to imperfections. It is thus possible for an image to be selected as to how many imperfections or impurities occur, for example, per unit area. Depending on this value, it can be decided whether the corresponding plastic preform is ejected or not.

In a further preferred method, the plastic preforms are inspected before they are heated.

In a further preferred method, the plastic preforms are plastic preforms that are transparent to visible light.

The present invention is further directed to an apparatus for producing plastic containers. This apparatus comprises a heating device, which heats plastic preforms, wherein said heating device having a transport device, which transports the plastic preforms along a predetermined transport path, and a forming device, which expands the plastic preforms heated by the heating device to form the plastic containers by application of a flowable medium, wherein the plastic preforms extending in a longitudinal direction and having several portions in said longitudinal direction, wherein said several portions having at least one threaded portion and/or mouth portion, a main body portion and a bottom portion. Furthermore, the apparatus has an inspection device which is suitable for inspecting at least the main body and the bottom portion of the plastic preforms, wherein the inspection device being suitable and intended to output values which are characteristic of a material quality of the plastic preforms.

Preferably, said values can be assigned to different portions of the plastic preforms. In particular, said values can be assigned to the main body portion and/or the bottom portion of the plastic preforms.

Therefore, it is also proposed on the apparatus side that an evaluation of the values or a value recording also be carried out in dependence on the respective portion of the plastic preform in which the values are recorded.

The apparatus preferably has an ejection device which is suitable and intended for ejecting plastic preforms taking into account at least one of these values.

In a further embodiment according to the invention, the apparatus comprises an ejection device which is suitable and intended for ejecting plastic preforms taking into account at least one of these values, wherein this ejection device also taking into account at least one value which is characteristic of the plastic preforms used and/or of the containers to be produced.

As mentioned above, it is relevant for production to know the regions in which there are imperfections. With specific container types, the bottoms of the containers, in particular petaloid bottoms, are particularly sensitive. Therefore, only a lower tolerance of imperfections is allowed for such containers. Other containers, for example containers with so-called champagne bottoms, are, on the other hand, less critical, so that even more imperfections are allowed.

Also in containers which are filled using a so-called hot filling method, the occurrence of defects, impurities or imperfections is also less critical because these containers are usually thicker walled. Particularly preferably, the criteria essential for the container are a geometric shape of a bottom portion of the container, a geometric shape of the main body or of the side walls of the container, a geometric shape of the mouth region of the containers to be produced, a desired wall thickness of the containers, information as to whether the containers are disposable or reusable containers and the like.

In a preferred embodiment, the ejection device is suitable and intended for ejecting plastic preforms, taking into account a first value which is characteristic of a material quality in the main body portion, and/or the ejection device is suitable and intended for ejecting plastic preforms, taking into account a first value which is characteristic of a material quality in the bottom portion of the container.

Preferably, the ejection device is arranged downstream of the heating device and particularly preferably upstream of the forming device. In a further advantageous embodiment, the inspection device is arranged upstream of the heating device.

Particularly preferably, the apparatus has a control device which controls the ejection device and controls it in particular such that containers or plastic preforms are or are not ejected. Particularly preferably, the control device controls the ejection device on the basis of values which are characteristic of material properties of the inspected plastic preform. Particularly preferably, the control device also controls the ejection device on the basis of values which are characteristic of an inspected portion of the plastic preform.

Particularly preferably, the control device controls the ejection device with respect to values characteristic of at least one property of the container to be produced and/or of at least one property of a blow mold of the blow-molding machine.

Furthermore, it would also be conceivable to form in the main body sub-portions for which different tolerances are selected with regard to material properties. Thus, for example, in the production of plastic preforms, certain portions of the plastic preform can be heated more intensely and also stretched more intensely than other portions. In such portions of the main body, it would be possible to permit only a smaller tolerance with respect to the material properties. This is advantageous in particular in the production of containers which have a cross section deviating from a circular cross section.

### BRIEF DESCRIPTION OF THE DRAWINGS

Further advantages and embodiments emerge from the accompanying figure. In the figures:

FIG. 1 shows a representation of a container; and

FIG. 2 shows a representation of a plastic preform from which the container shown in FIG. 1 is produced

### DETAILED DESCRIPTION OF THE INVENTION

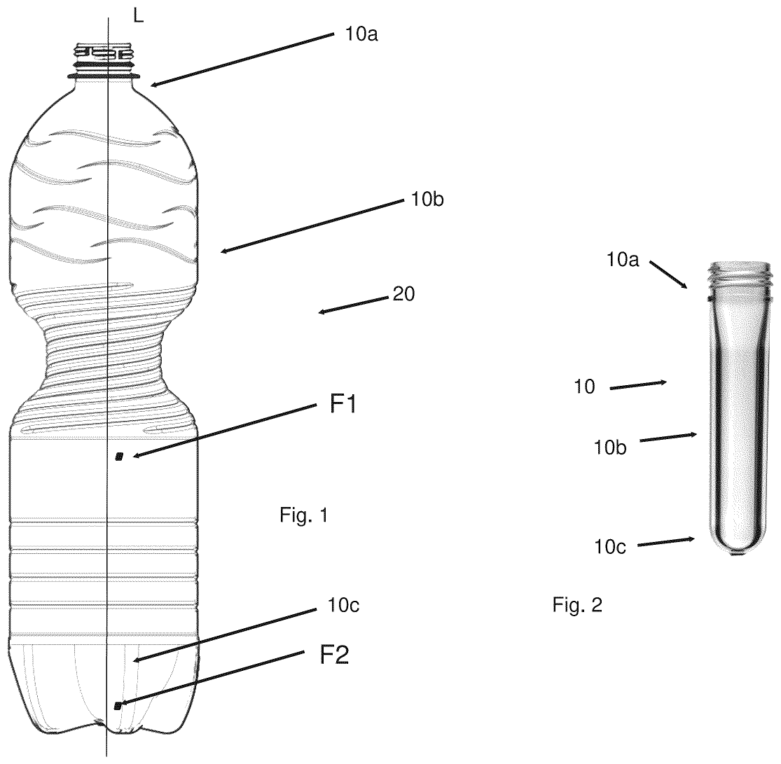

FIG. 1 shows a representation of a container 20. Said container has a longitudinal direction L and in this case three portions 10a, 10b, and 10c. More precisely, these are a mouth portion 10a, a main body portion 10b and a bottom portion 10c.

Said portions correspond to the corresponding portions of the plastic preforms 10 shown in FIG. 2 from which the container 20 is produced by a blow-molding process. The mouth portion 10a is preferably not expanded here.

The reference number F1 identifies a fault, such as a dark point, which is located in the main body portion 10b, and the reference sign F2 identifies a fault in the region of the bottom portion 10c. These two faults F1 and F2 can have different effects. It is thus conceivable that the fault F1 in the main body portion 10b does not yet lead to a defective container, whereas the fault F2 in the bottom portion 10c leads to a defective container. In this case, a plastic preform with the fault F2 should therefore be ejected, whereas a plastic preform with the fault F1 should not.

1. A method for evaluating plastic preforms, wherein said plastic preforms are intended to be heated by a heating device and then expanded by a forming device by application of a flowable medium to form plastic containers, wherein the plastic preforms extending in a longitudinal direction and having several portions in the longitudinal direction, wherein the several portions having at least one mouth portion, a main body portion and a bottom portion, wherein at least the main body portion and the bottom portion being inspected, wherein
values characteristic of a material quality of the plastic preforms are output, wherein the values being assigned to different portions and/or wherein at least one property of the container to be produced being taken into account in the evaluation of the characteristic values.

2. The method according to claim 1,
wherein
the values characteristic of the material quality are selected from a group of values selected from impurities of the material of the plastic preforms, sizes of the impurities of the material, a distribution of the impurities of the material over the surface thereof, a density of the impurities of the material over the surface thereof, thickness variations of a material of the plastic preforms, density variations of a material of the plastic preforms, and color properties of the material of the plastic preforms.

3. The method according to claim 1,
wherein
at least one characteristic value is determined which is characteristic of the main body portion of the plastic preforms and/or at least one characteristic value is determined which is characteristic of the bottom portion or a wall portion of the plastic preforms.

4. The method according to claim 1,
wherein
the plastic preforms are transported along a predetermined transport path and are inspected during this transport.

5. The method according to claim 1,
wherein
the plastic preforms have at least in part a recycled material.

6. The method according to claim 1,
wherein
the plastic preforms are heated after the inspection thereof and are expanded after the heating thereof.

7. The method according to claim 1,
wherein
a portion of the plastic preforms is ejected before the expansion thereof and after the heating thereof.

8. The method according to claim 7,
wherein
an ejection takes place taking into account at least one of the values, and the ejection takes place both taking into account the values and taking into account the portion in which this value was determined.

9. The method according to claim 1,
wherein
an inspection of the plastic preforms takes place before the heating thereof.

10. An apparatus for producing plastic containers comprising a heating device, configured to heat plastic preforms, wherein the heating device having a transport device configured to transport the plastic preforms along a predetermined transport path and a forming device, configured to expand the plastic preforms heated by the heating device by application of a flowable medium to form the plastic containers, wherein the plastic preforms extending in a longitudinal direction and having several portions in the longitudinal direction, wherein the several portions having at least one mouth portion, a main body portion and a bottom portion, and comprising at least one inspection device configured for inspecting at least one main body and the bottom portion of the plastic preforms, wherein the inspection device is configured for outputting values which are characteristic of a material quality of the plastic preforms,
wherein
the values can be assigned to different portions of the plastic preforms and/or the apparatus comprises an ejection device which is configured for ejecting plastic preforms taking into account at least one of the values, wherein the ejection device also taking into account at least one value which is characteristic of the plastic preforms used and/or of the containers to be produced.

11. The apparatus according to claim 10,
wherein
the apparatus has an ejection device which is configured for ejecting plastic preforms taking into account at least one of these values.

12. The apparatus according to claim 11,
wherein
the ejection device is configured for ejecting plastic preforms taking into account a first value which is characteristic of a material quality in the main body portion and/or the ejection device is configured for ejecting plastic preforms taking into account a first value which is characteristic of a material quality in the bottom portion.
